(19) United States
(12) Patent Application Publication
(10) Pub. No.: US 2007/0143534 A1
(43) Pub. Date: Jun. 21, 2007

(54) Nonvolatile-memory-access control apparatus and nonvolatile-memory control system

(75) Inventors: Takuya Hashimoto, Kanagawa (JP); Kunihiro Miura, Kanagawa (JP); Toshinori Nakamura, Kanagawa (JP); Hideo Nomura, Kanagawa (JP); Kenichi Satori, Tokyo (JP); Kenichi Nakanishi, Tokyo (JP); Naohiro Adachi, Kanagawa (JP); Tamaki Konno, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/607,882

(22) Filed: Dec. 4, 2006

(30) Foreign Application Priority Data
Dec. 20, 2005 (JP) 2005-366432

(51) Int. Cl. G06F 12/00

(52) U.S. Cl. 711/103

(57) ABSTRACT

A nonvolatile-memory-access control apparatus controls operations for accessing a nonvolatile memory, which include plural cycles by a processing device. The nonvolatile-memory-access control apparatus includes a nonvolatile-memory-access-operation control unit that is capable of setting information on a series of nonvolatile-memory-access operations of the plural cycles, and when a request for access to the nonvolatile memory is received from the processing device, the unit is capable of controlling a series of operations for accessing the nonvolatile memory on the basis of the information set.

### CROSS-REFERENCES TO RELATED APPLICATIONS

This application contains subject matter related to Japanese Patent Application JP 2005-366432 filed in the Japanese Patent Office on Dec. 20, 2005, the entire contents of which being incorporated herein by reference.

### BACKGROUND OF THE INVENTION

1. Field of the Invention

The present invention relates to a nonvolatile-memory-access control apparatus and a nonvolatile-memory control system for a flash memory and the like.

2. Description of the Related Art

In a nonvolatile-memory-access control system for a flash memory and the like, in accessing a nonvolatile memory, a CPU serving as a processing device controls operations for accessing the nonvolatile memory to execute processing in accordance with the operations as shown in FIG. 1.

The CPU controls nonvolatile-memory-access operations by performing processing for setting, for one nonvolatile memory access, an operation in a nonvolatile-memory-access-operation control unit to generate a control signal and a chip select signal for the nonvolatile memory access and inputting data to and outputting data from a data path for the nonvolatile memory.

For example, the CPU performs control for, in issuing a command to the nonvolatile memory, setting the nonvolatile-memory-access-operation control unit to issue the command, generating a command control signal and a chip select signal according to the setting, and outputting the command to the data path.

When a user transfers addresses and input/output data, a volume that can be access at a time is not determined. Since it is difficult to transmit addresses and data having a large volume at a time, it is necessary to transfer the addresses and the input/output data, which the user desires to transfer, separately plural times.

Access control for a nonvolatile memory is proposed in, for example, JP-A-2002-133878 and JP-A-2003-141888.

### SUMMARY OF THE INVENTION

In a general nonvolatile memory, there are a command cycle, an address cycle, a data cycle, and a busy (BSY) cycle. Thus, when the control method described above is used, the CPU intervenes once or more for one cycle. In other words, the number of times of processing by the CPU is one or more for one cycle. Therefore, in continuously applying writing and reading to the nonvolatile memory, since the CPU intervenes plural times, there is an inconvenience that the number of times of processing by the CPU increases, operations for accessing the nonvolatile memory is delayed, and power consumption of the CPU increases.

Thus, it is desirable to provide a nonvolatile-memory-access control apparatus and a nonvolatile-memory control system that can reduce an increase in the number of times of processing by a processing device, prevent operations for accessing a nonvolatile memory from being delayed, and realize a reduction in power consumption.

According to a first embodiment of the invention, there is provided a nonvolatile-memory-access control apparatus that controls operations for accessing a nonvolatile memory, which include plural cycles by a processing device. The nonvolatile-memory-access control apparatus includes a nonvolatile-memory-access-operation control unit that is capable of setting information on a series of nonvolatile-memory-access operations of the plural cycles, and when a request for access to the nonvolatile memory is received from the processing device, the unit is capable of controlling a series of operations for accessing the nonvolatile memory on the basis of the information set.

Preferably, the nonvolatile-memory-access-operation control unit includes a state holding unit that can set states corresponding to the respective cycles at the time of nonvolatile memory access.

Preferably, the plural cycles at the time of nonvolatile memory access include at least a command cycle for issuing a command, an address cycle for issuing an address, a data cycle for inputting data to and outputting data from a data path for the nonvolatile memory, and a busy cycle that is busy time of the nonvolatile memory. The state holding unit includes: a command-state holding section corresponding to the command cycle; an address-state holding section corresponding to the address cycle; a data-state holding section correspond to the data cycle; and a busy-state holding section corresponding to the busy cycle.

Preferably, the nonvolatile-memory-access-operation control unit further includes: a command holding unit that holds a command issued at the time of the command cycle; an address holding unit that holds an address issued at the time of the address cycle; a number-of-states holding unit that determines the number of states of access; a number-of-counts holding unit for counting the number of addresses and the number of data states; and a number-of-state-cycles control counter that counts the number of state cycles necessary for access.

Preferably, the nonvolatile-memory-access-operation control unit checks, when a request for starting access to the nonvolatile memory is received from the processing device, the state holding unit to determine in which order of the cycles the access should be performed and performs access control in accordance with the order determined.

Preferably, the nonvolatile-memory-access-operation control unit checks, when a request for starting access to the nonvolatile memory is received from the processing device, the state holding unit to determine in which order of the cycles the access should be performed, performs access control in accordance with the order determined, and, when processing of predetermined cycles ends, shifts to the next cycle or judges an access end according to a result of comparison of a value of the number-of-states holding unit and a value of the number-of-state-cycles control counter.

According to a second embodiment of the invention, a nonvolatile memory control system includes: a nonvolatile memory; a processing device that requests access to the nonvolatile memory; and a nonvolatile-memory-access control apparatus that controls operations for accessing the nonvolatile memory, which include plural cycles, according to a request of the processing device. The nonvolatile-memory-access control apparatus includes a nonvolatile-memory-access-operation control unit that is capable of setting information on a series of nonvolatile-memory-access operations of the plural cycles, and when a request for access to the nonvolatile memory is received from the processing device, the unit is capable of controlling a series of operations for accessing the nonvolatile memory on the basis of the information set.

According to the embodiments of the invention, it is possible to realize a reduction in loads on a processing device through a decrease in the number of times of intervention of the processing device, realize improvement of a data transfer rate, and realize control of power consumption of the processing device.

It is possible to execute, without the intervention of the processing device, a series of nonvolatile-memory-access operations such as operations for writing data in and reading out data from a nonvolatile memory on the basis of set information.

When data of a large volume is transferred from the nonvolatile memory, it is possible to perform higher-speed nonvolatile memory access while reducing the number of times of processing by the processing device.

It is possible to flexibly cope with, without increasing the number of times of processing by the processing device, a complicated nonvolatile-memory-access operation in which the number of times of access increases because of extension of functions of the nonvolatile memory and the number of cycles increases in one access.

### BRIEF DESCRIPTION OF THE DRAWINGS

In the accompanying drawings:

FIG. 1 is a diagram for explaining operations for accessing a general nonvolatile memory;

FIG. 2 is a block diagram showing an example of a structure of a nonvolatile-memory-control system according to an embodiment of the invention;

FIGS. 3A and 3B are diagrams showing examples of wiring of a supply line for a chip enable signal XCE in a stack flash and an output line for ready RDY and a busy signal XBSY;

FIG. 4 is a diagram showing usual status read;

FIG. 5 is a diagram showing execution of polling of the status read;

FIG. 6 is a diagram showing an example of a structure of a nonvolatile-memory-access-operation control unit according to the embodiment;

FIG. 7 is a diagram showing an example of a structure of a register group for nonvolatile-memory-access control according to the embodiment;

FIG. 8 is a diagram showing an example of setting of respective state registers in a sequence register according to the embodiment;

FIG. 9 is a diagram for explaining an example of extension of the number of stages (the number of bits) of state registers;

FIG. 10 is a diagram for explaining an example of an increase in the number of state registers; and

FIG. 11 is a diagram for explaining an example of an increase in the number of sequence registers.

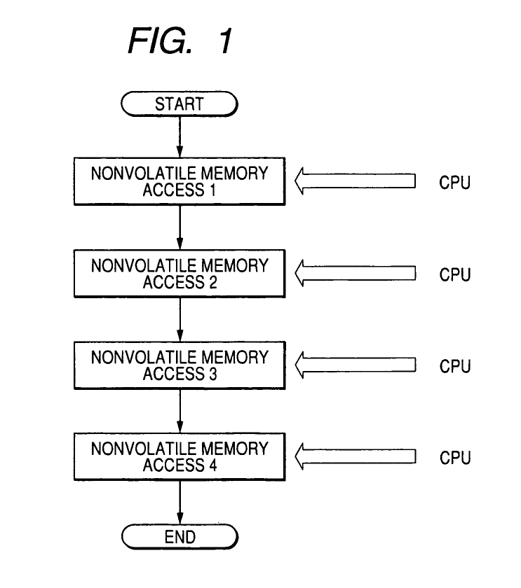

### DESCRIPTION OF THE PREFERRED EMBODIMENTS

An embodiment of the invention will be hereinafter explained with reference to the drawings.

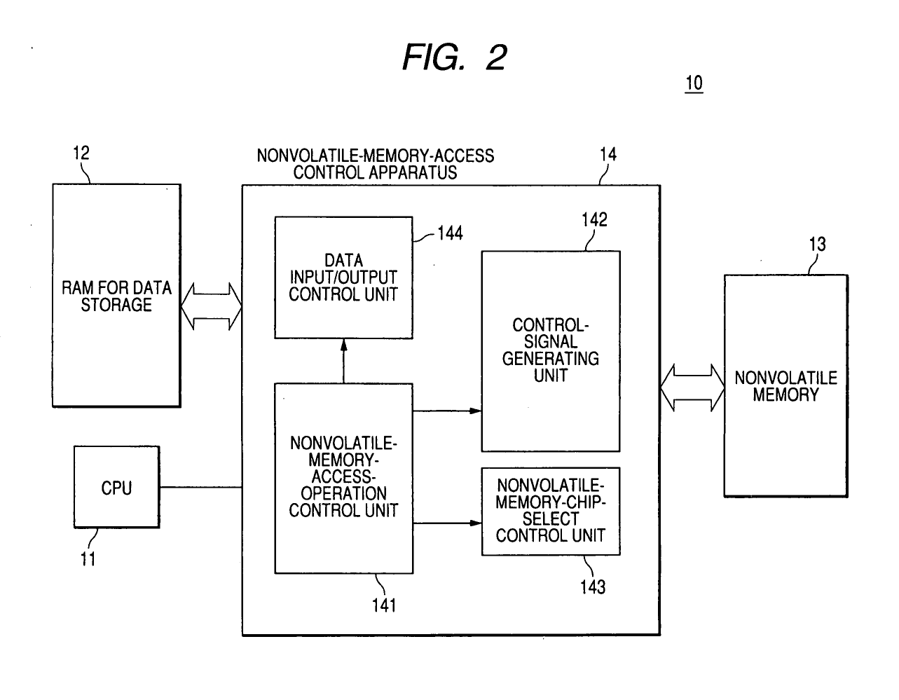

FIG. 2 is a block diagram showing an example of a structure of a nonvolatile-memory-control system according to the embodiment of the invention.

The nonvolatile-memory-control system 10 includes, as shown in FIG. 2, a CPU 11 serving as a processing device, a RAM for data storage 12, a nonvolatile memory 13, and a nonvolatile-memory-access control apparatus 14.

The CPU 11 performs processing for, for example, reading out data stored in the nonvolatile memory 13 through the nonvolatile-memory-access control apparatus 14 to perform predetermined processing and writing the data subjected to the predetermined processing in the nonvolatile memory 13.

In performing such access to the nonvolatile memory 13, the CPU 11 instructs the nonvolatile-memory-access control apparatus 14 to, for example, issue a command to the nonvolatile memory 13 and designate an address.

The RAM for data storage 12 is constituted by an SRAM or the like. Data generated in access to the nonvolatile memory 13 is written in or read out from the RAM for data storage 12 at random by the nonvolatile-memory-access control apparatus 14.

The nonvolatile memory 13 is constituted by, for example, a NAND flash memory.

The NAND flash memory adopted for the nonvolatile memory 13 is formed by a flash memory with 2 KB/page and 64 pages/block.

The flash memory (the nonvolatile memory) 13 according to this embodiment is constituted by a so-called stack flash that includes two or four physical chips (stack memories SMs) in the inside of a package.

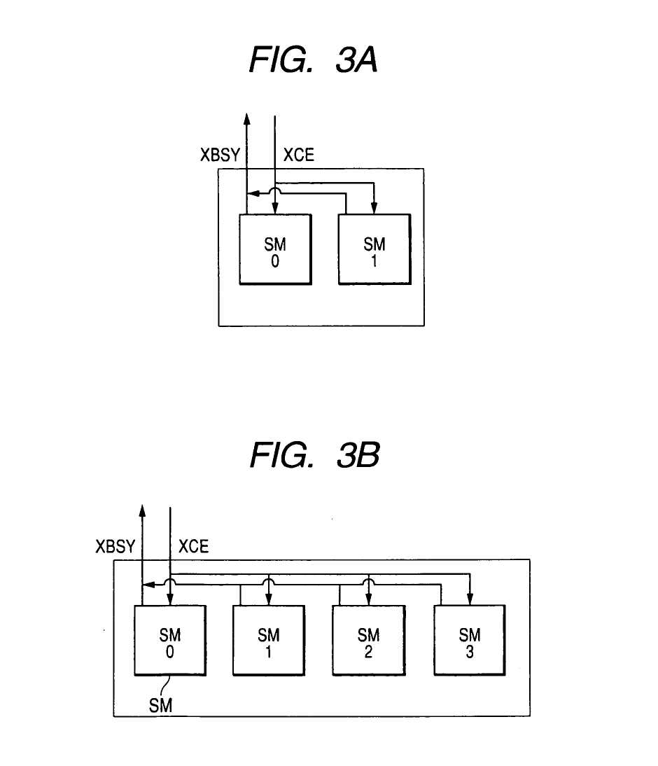

The respective stack memories SMs, which are the physical chips forming the stack flash, can take a ready state or a busy state individually. However, in this embodiment, one supply line for a chip enable signal XCE supplied by the nonvolatile-memory-access control apparatus 14 and one output line for ready RDY and a busy signal XBSY outputted to the nonvolatile-memory-access control apparatus 14 are wired in a package, respectively as shown in FIGS. 3A and 3B.

In the stack flash, even if one of two stack memories SMO and SM1 or four stack memories SMO to SM3, which are the physical chips, is in the busy state, the other stack memories can be in the ready state. In this case, since there is only one RDY/XBSY line, the RDY/XBSY is busy BSY. Therefore, the nonvolatile-memory-access control apparatus 14 may not be able to judge, with the RDY/XBSY line, the busy or ready state of the other stack memories (the physical chips).

Thus, when the stack flash is adopted as the nonvolatile memory 13, in judging the busy or ready state, the nonvolatile-memory-access control apparatus 14 according to this embodiment executes polling status read.

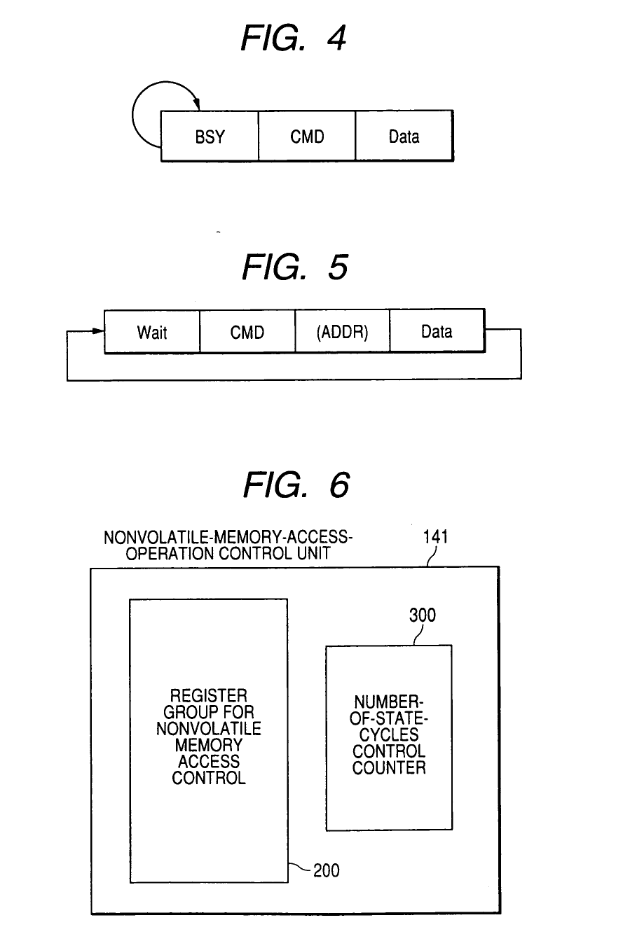

This means that the nonvolatile-memory-access control apparatus 14 according to this embodiment has a function for executing polling for status read shown in FIG. 5 in addition to usual status read shown in FIG. 4.

The execution of the polling for status read is, unlike the usual status read, a method of executing status read corresponding to the stack flash.

The status read by polling is performed in a sequence for issuing status read when a polling period set elapses, when a result of the status read is busy BSY, waiting for the polling period to elapse again, and, then, executing the status read again.

When a result of the status read by polling is busy BSY even after time for timeout elapses, the nonvolatile-memory-access control apparatus 14 executes timeout and ends the sequence of the status read by polling.

The nonvolatile-memory-access control apparatus 14 sets the polling period and the timeout time according to a wait count (WAIT_CNT) and a wait cycle (WAIT_CYC) of a status-read control register.

During the polling, when the XBSY line becomes high (ready), the nonvolatile-memory-access control apparatus 14 stops the wait, which complies with the polling period setting, and immediately executes an object sequence. Specifically, the nonvolatile-memory-access control apparatus 14 issues a status read command and reads a status value.

At the time of execution of the status read by polling, when a BSY state is present in the sequence, the nonvolatile-memory-access control apparatus 14 interprets the BSY state as a predetermined state (a NOP state) and executes the sequence.

A specific structure and functions (excluding the function for executing the polling for status read) of the nonvolatile-memory-access control apparatus 14 according to this embodiment will be hereinafter explained.

The nonvolatile-memory-access control apparatus 14 includes, as shown in FIG. 2, a nonvolatile-memory-access-operation control unit 141, a control-signal generating unit 142, a nonvolatile-memory-chip-select control unit 143, and a data input/output control unit 144 as main components.

The nonvolatile-memory-access-operation control unit 141 is capable of setting a command, an address, the number of state cycles, and the like for access from the CPU 11 to the nonvolatile memory 13. The nonvolatile-memory-access-operation control unit 141 is capable of controlling, according to set information, operations for access to the nonvolatile memory 13, reducing the number of times of processing by the CPU 11, and performing a high-speed flash access operation.

Further, the nonvolatile-memory-access-operation control unit 141 is capable of setting states corresponding to respective cycles at the time of access to the nonvolatile memory 13. The nonvolatile-memory-access-operation control unit 141 is capable of flexibly controlling not only operations for writing data in and reading out data from the nonvolatile memory 13 but also complicated operations for access to the nonvolatile memory 13.

The control-signal generating unit 142 generates a control signal for access to the nonvolatile memory 13 under the control by the nonvolatile-memory-access-operation control unit 141.

The nonvolatile-memory-chip-select control unit 143 generates a chip select signal (including a chip enable signal XCE) under the control by the nonvolatile-memory-access-operation control unit 141.

The data input/output control unit 144 performs processing for inputting data to and outputting data from the data path for the nonvolatile memory 13 under the control by the nonvolatile-memory-access-operation control unit 141.

Plural cycles are necessary for a series of access operations such as writing of data in the nonvolatile memory 13 and readout of data from the nonvolatile memory 13.

In a general nonvolatile memory, there are four cycles, namely, a command cycle for issuing a command, an address cycle for issuing an address, a data cycle for inputting writing data to and outputting readout data from the data path, and a BSY cycle that is busy time of the nonvolatile memory.

The nonvolatile-memory-access-operation control unit 141 according to this embodiment includes, as shown in FIG. 6, a register group for nonvolatile memory access control (a holding unit group) 200 and a number-of-state-cycles control counter 300 in order to realize an increase in speed of access to the nonvolatile memory 13 through a reduction in the number of times of CPU processing.

In the following explanation, a state holding unit or the like that holds state information is formed by a register. However, the state holding unit or the like is not limited to the register.

The nonvolatile-memory-access-operation control unit 141 according to this embodiment is roughly constituted by two register groups.

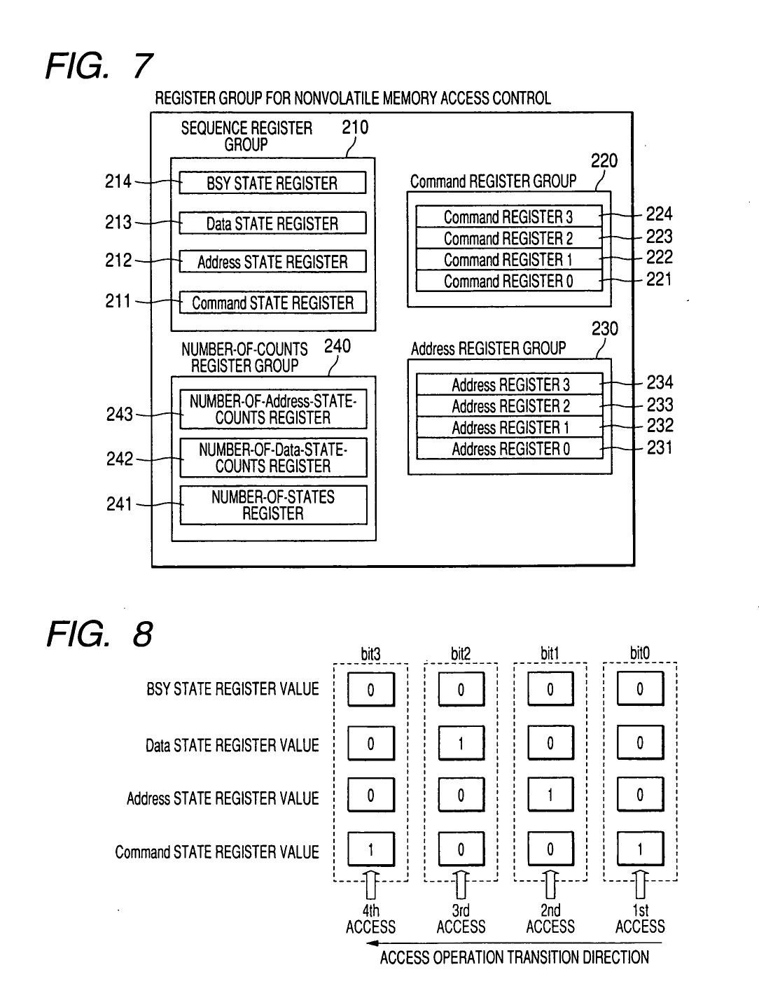

As shown in FIG. 7, the register group for nonvolatile memory access control 200 is formed of four register groups.

A first register group is a sequence register group 210. The sequence register group 210 holds states corresponding to the respective cycles of access to the nonvolatile memory 13. The sequence register group 210 includes a command state register 211 corresponding to the command cycle, an address state register 212 corresponding to the address cycle, a data state register 213 corresponding to the data cycle, and a busy (BSY) state register 214 corresponding to the busy (BSY) cycle.

A second register group is a command register group 220 that holds a command issued at the time of the command cycle.

A third register group is an address register group 230 that holds an address issued at the time of the address cycle.

A fourth register group is a number-of-counts register group 240 including, for example, a number-of-states register that determines the number of states of access executed at the point of the access.

The number-of-state-cycles control counter 300 counts states necessary for access to the nonvolatile memory 13.

In the register group for nonvolatile memory access control 200 shown in FIG. 7, the command register group 220 includes plural (four in FIG. 7) command registers 221 to 224.

Similarly, the address register group 230 includes plural (four in FIG. 7) address registers 231 to 234.

The number-of-counts register group 240 includes a number-of-states register 241, a number-of-data-state-counts register 242, and a number-of-address-state-counts register 243.

A method of setting and controlling a nonvolatile memory will be hereinafter explained with an operation for writing in the nonvolatile memory as an example.

In the case of the writing operation, data is read out from the RAM for data storage 12 in FIG. 2 and written in the nonvolatile memory 13 by accessing the nonvolatile memory 13 in the command cycle, the address cycle, the data cycle, and the command cycle in this order.

Since a first cycle of access to the nonvolatile memory 13 is the command cycle, “1” is set in the command state register (0) 211 and “0” is set in the address state register (0) 212, the data state register (0) 213, and the busy (BSY) state register (0) 214 of the sequence register group 210 in FIG. 7.

Since a second cycle is the address cycle, “1” is set in the address state register (1) 212 and “0” is set in the other state registers (1) 211, 213, and 214.

Similarly, in the data cycle, which is a third cycle, “1” is set in only the data state register (2) 213. In the command cycle, which is a fourth cycle, “1” is set in only the command state register (3) 211.

A value (e.g., 80h) corresponding to the first command cycle is set in the command register (0) 211 and a value corresponding to the second command cycle is set in the command register (1) 222 of the command register group 220.

For example, “80h” is set in the command register (0) 221 and “10h” is set in the command register (1) 222.

An address value of the nonvolatile memory accesses at the time of the writing is set in an address register. In the case of writing of data in the nonvolatile memory, since four cycles are necessary, a value of “4” is set in a not-shown number-of-access-cycles register for setting the number of access cycles.

When a request for starting access to the nonvolatile memory 13 is received from the CPU 11, first, the nonvolatile-memory-access control apparatus 14 checks values of the respective state registers (0) 211 to 214 to determine which cycle should be performed.

In the case of data writing, since a value of the command state register (0) 211 is “1”, first, the nonvolatile-memory-access control apparatus 14 determines to execute the command cycle on the nonvolatile memory 13. The nonvolatile-memory-access control apparatus 14 generates command control signal in the control-signal generating unit 142. The value (“80h”) of the command register (0) 221 is outputted from the data input/output control unit 144 to the data path for the nonvolatile memory 13. In the case of this example, “80h” is outputted to the data path.

When the command cycle ends, the nonvolatile-memory-access control apparatus 14 increments a state-cycle count value by 1 and checks a value of the number-of-states register 241. When the state-cycle count value and the value of the number-of-states register 241 do not coincide with each other, the nonvolatile-memory-access control apparatus 14 shifts to the next access and checks values of the respective state registers (1) 211 to 214.

Since the second cycle is the address cycle, as in the case of the command cycle, the nonvolatile-memory-access control apparatus 14 generates an address control signal from the control signal generating unit 142 and outputs an address register value to the data path for the nonvolatile memory 13 to enter the address cycle.

Since the third cycle is the data cycle, the nonvolatile-memory-access control apparatus 14 generates a data-output control signal in the control-signal generating unit 142, reads out data from the RAM for data storage 12, and outputs the data to the data path for the nonvolatile memory 13.

Since a fourth cycle is the command cycle, although an operation is the same as that in the first cycle, a command value issued is a value (“10h”) of the command register (1) 222. In the case of this example, “10h” is outputted to the data path.

When the fourth cycle ends, since the state-cycle count value coincides with a number-of-states register value, the nonvolatile-memory-access control apparatus 14 ends the access to the nonvolatile memory 13 and notifies the CPU 11 of the end of the access.

Since a bus width of the nonvolatile memory 13 is determined, it is difficult to transfer addresses and data of a volume exceeding the bus width by executing a state once. This problem is solved by mounting components described below.

The components are a counter that can count the number of times of repetition of an address state and a data state at the time of the transfer, that is, the number-of-state-cycles control counter 300 in FIG. 6 and the number-of-address-state-counts register 243 and the number-of-data-state-counts register 242 in FIG. 7 that hold the number of times of repetition.

In the case of the address state, the nonvolatile-memory-access control apparatus 14 actuates an address-state-cycle counter of the number-of-state-cycles control counter 30. When a counter value of the address-state-cycle counter coincides with a value of the number-of-address-state-counts register 243, the nonvolatile-memory-access control apparatus 14 shifts to the next cycle or ends the access.

In the case of the data state, by performing control in the same manner, it is possible to transfer addresses and data of a volume exceeding the bus width by executing the address state and the data state once.

Consequently, it is possible to set an order of access to the nonvolatile memory 13 as shown in, for example, FIG. 8.

In the case of FIG. 8, the command state register 211, the address state register 212, the data state register 213, and the busy (BSY) state register 214 are formed of four bits. Bits of the respective state registers in which “1” is set are transitioned in time series.

The example in FIG. 8 corresponds to the operation example described above.

In this way, the sequence register group 210 that transitions an order of access to the nonvolatile memory 13 in time series to control operations for accessing the nonvolatile memory 13, the number-of-state-cycles control counter 300 that controls the number of states of access, the number-of-address-state-counts register 243 that controls the number of times of continuous execution of the address state, and the number-of-data-state-counts register 242 that controls the number of times of continuous execution of the data state are mounted on the nonvolatile-memory-access-operation control unit 141. This makes it possible to control a series of control operations for accessing the nonvolatile memory 13.

It is possible to flexibly cope with various nonvolatile memory access operations other than the operations such as writing and readout and a new nonvolatile memory with an extended command input system different from the existing nonvolatile memory by changing a value of the register group for nonvolatile memory access control 200.

For example, in data readout, in the case of data readout from the nonvolatile memory 13, data is read out in the command state, the address state, the command state, the busy (BSY) state, and the data state in this order. Thus, in order to change an operation for writing data in the nonvolatile memory 13 to an operation for reading out data from the nonvolatile memory 13, it is possible to flexibly and easily cope with the change by resetting values of the respective storages in the order of access, setting a number-of-state-cycles register value to “5”, and changing a value of the command register to a set value for performing the operation for reading out data from the nonvolatile memory 13.

It is possible to realize first function extension to fourth function extension described below on the basis of this circuit.

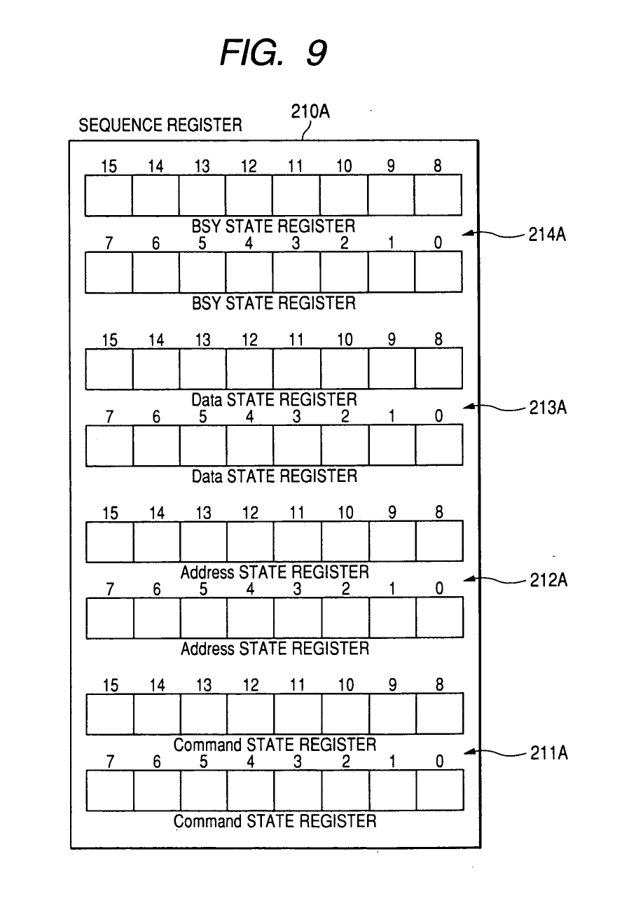

First, it is possible to increase a maximum number of times of access to a nonvolatile memory in one access to the nonvolatile memory by, as shown in FIG. 9, increasing the numbers of stages (the numbers of bits) of the respective state registers.

For example, when the respective state registers 211A to 214A are extended to 16 bits as shown in FIG. 9, it is possible to execute operations for accessing the nonvolatile memory up to sixteen cycles without the intervention of the CPU 11.

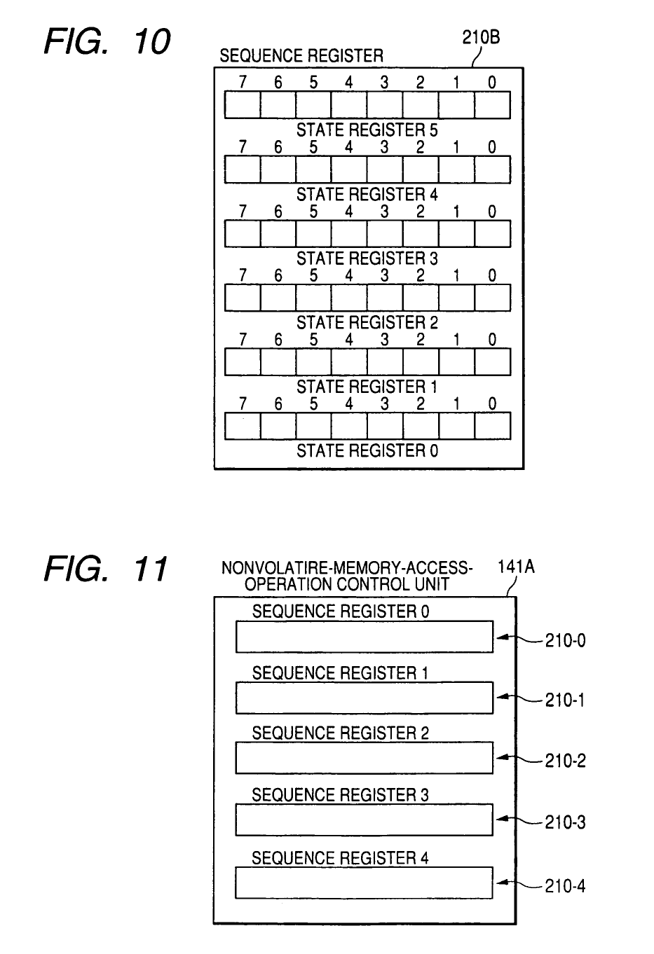

Second, it is also possible to cope with presence of cycles other than the existing cycles by, as shown in FIG. 10, increasing the types (the number) of the state registers.

For example, it is possible to cope with presence of cycles equal to or more than four cycles in the nonvolatile memory 13 by, as shown in FIG. 10, increasing the number of state registers to six.

Third, it is possible to set various plural operations for accessing the nonvolatile memory 13 by, as shown in FIG. 11, increasing the number of sequence registers.

For example, a writing operation is set in a sequence register (0) 210-0 and a readout operation is set in a sequence register (2) 210-2 in FIG. 11 in advance. After writing is executed on the basis of a setting state of the sequence register (0) 210-0, readout is executed on the basis of a setting state of the sequence register (2) 210-2. Consequently, it is possible to continuously execute writing and readout operations without the intervention of the CPU 11

Fourth, it is possible to repeatedly execute a series of operations set in sequence registers continuously by mounting, on the nonvolatile memory 13, a “sequence-register continuous-execution-number-of-times counter” that counts the number of times of a series of operations for accessing the nonvolatile memory 13.

For example, it is possible to execute transfer of data of a large volume without the intervention of the CPU 11 by setting the operations as in the third case described above and controlling the “sequence-register continuous-execution-number-of-times counter”.

It is possible to realize flexible nonvolatile memory access if the first to the fourth constitutions are mounted in combination.

Moreover, it is also possible to perform high-speed nonvolatile memory access while reducing a circuit size and decreasing intervention of a CPU by storing a setting, which can be controlled by such an operation method, in a FIFO or a RAM, which serves as the holding unit, rather than the register.

As explained above, according to this embodiment, the nonvolatile-memory-control system 10 includes the nonvolatile memory 13, the CPU (the processing device) 11 that requests access to the nonvolatile memory 13, and the nonvolatile-memory-access control apparatus 14 that controls operations for accessing the nonvolatile memory 13, which include plural cycles, according to a request of the CPU 11. The nonvolatile-memory-access control apparatus 14 is capable of setting information on a series of nonvolatile-memory-access operations of the plural cycles. The nonvolatile-memory-access control apparatus 14 includes the nonvolatile-memory-access-operation control unit 141 that controls, when a request for access to the nonvolatile memory 13 is received from the CPU 11, a series of operations for accessing the nonvolatile memory 13 on the basis of the information set. Thus, it is possible to obtain effects described below.

It is possible to realize a reduction in loads on a CPU through a decrease in the number of times of intervention of the CPU, realize improvement of a data transfer rate, and realize control of power consumption of the CPU.

Since the CPU sets data including transition values of registers, thereafter, it is possible to execute, without the intervention of the CPU, a series of nonvolatile-memory-access operations such as operations for writing data in and reading out data from a nonvolatile memory on the basis of set information.

When data of a large volume is transferred from the nonvolatile memory, it is possible to perform higher-speed nonvolatile memory access while reducing the number of times of processing by the CPU.

Moreover, it is possible to flexibly cope with, without increasing the number of times of processing by the CPU, a complicated nonvolatile-memory-access operation in which the number of times of access increases because of extension of functions of the nonvolatile memory and the number of cycles increases in one access.

It should be understood by those skilled in the art that various modifications, combinations, sub-combinations, and alterations may occur depending on design requirements and other factors insofar as they are within the scope of the appended claims or the equivalents thereof.

What is claimed is:

1. A nonvolatile-memory-access control apparatus that controls operations for accessing a nonvolatile memory, which include plural cycles by a processing device, the nonvolatile-memory-access control apparatus comprising:
a nonvolatile-memory-access-operation control unit that is capable of setting information on a series of nonvolatile-memory-access operations of the plural cycles, and when a request for access to the nonvolatile memory is received from the processing device, the unit is capable of controlling a series of operations for accessing the nonvolatile memory on the basis of the information set.

2. A nonvolatile-memory-access control apparatus according to claim 1, wherein the nonvolatile-memory-access-operation control unit includes a state holding unit that can set states corresponding to the respective cycles at the time of nonvolatile memory access.

3. A nonvolatile-memory-access control apparatus according to claim 2, wherein
the plural cycles at the time of nonvolatile memory access include at least a command cycle for issuing a command, an address cycle for issuing an address, a data cycle for inputting data to and outputting data from a data path for the nonvolatile memory, and a busy cycle that is busy time of the nonvolatile memory, and
the state holding unit includes:
a command-state holding section corresponding to the command cycle;
an address-state holding section corresponding to the address cycle;
a data-state holding section correspond to the data cycle; and
a busy-state holding section corresponding to the busy cycle.

4. A nonvolatile-memory-access control apparatus according to claim 3, wherein the nonvolatile-memory-access-operation control unit further includes:
a command holding unit that holds a command issued at the time of the command cycle;
an address holding unit that holds an address issued at the time of the address cycle;
a number-of-states holding unit that determines the number of states of access;
a number-of-counts holding unit for counting the number of addresses and the number of data states; and
a state-cycle control counter that counts the number of state cycles necessary for access.

5. A nonvolatile-memory-access control apparatus according to claim 2, wherein the nonvolatile-memory-access-operation control unit checks, when a request for starting access to the nonvolatile memory is received from the processing device, the state holding unit to determine in which order of the cycles the access should be performed and performs access control in accordance with the order determined.

6. A nonvolatile-memory-access control apparatus according to claim 3, wherein the nonvolatile-memory-access-operation control unit checks, when a request for starting access to the nonvolatile memory is received from the processing device, the state holding unit to determine in which order of the cycles the access should be performed and performs access control in accordance with the order determined.

7. A nonvolatile-memory-access control apparatus according to claim 4, wherein the nonvolatile-memory-access-operation control unit checks, when a request for starting access to the nonvolatile memory is received from the processing device, the state holding unit to determine in which order of the cycles the access should be performed, performs access control in accordance with the order determined, and, when processing of predetermined cycles ends, shifts to a next cycle or judges an access end according to a result of comparison of a value of the number-of-states holding unit and a value of the number-of-state-cycles control counter.

8. A nonvolatile memory control system comprising:
a nonvolatile memory;
a processing device that requests access to the nonvolatile memory; and
a nonvolatile-memory-access control apparatus that controls operations for accessing the nonvolatile memory, which include plural cycles, according to a request of the processing device, wherein
the nonvolatile-memory-access control apparatus includes a nonvolatile-memory-access-operation control unit that is capable of setting information on a series of nonvolatile-memory-access operations of the plural cycles, and when a request for access to the nonvolatile memory is received from the processing device, the unit is capable of controlling a series of operations for accessing the nonvolatile memory on the basis of the information set.

9. A nonvolatile memory control system according to claim 8, wherein the nonvolatile-memory-access-operation control unit includes a state holding unit that can set states corresponding to the respective cycles at the time of nonvolatile memory access.

10. A nonvolatile memory control system according to claim 9, wherein the nonvolatile-memory-access-operation control unit checks, when a request for starting access to the nonvolatile memory is received from the processing device, the state holding unit to determine in which order of the cycles the access should be performed and performs access control in accordance with the order determined.
